(19) United States
(12) Patent Application Publication
(10) Pub. No.: US 2020/0034903 A1
(43) Pub. Date: Jan. 30, 2020

(54) Information Processing Method, Information Processing Apparatus and Computer-Readable Non-Transitory Storage Medium Storing Program

(71) Applicant: Mercari, Inc., Minato-ku (JP)

(72) Inventors: Masato Yamamoto, Minato-ku (JP); Keisuke Sogawa, Minato-ku (JP)

(21) Appl. No.: 16/520,787

(22) Filed: Jul. 24, 2019

(30) Foreign Application Priority Data
Jul. 25, 2018 (JP) 2018-139485

(51) Int. Cl. G06Q 30/06

(52) U.S. Cl. CPC G06Q 30/0619; G06Q 30/0633

(57) ABSTRACT

There is provided an information processing method and the like capable of using an electronic commerce platform by work that is simpler than before. When finding a desired commodity at a member shop, a user performs smartphone settlement using a user terminal 120 to purchase the commodity. A settlement terminal 130 generates purchase information, being triggered by the smartphone settlement and transmits it to a mediation server 110. When receiving, from the user terminal 120, a notification to the effect that a user wants to list the commodity purchased at the member shop on an electronic commerce platform (application for sale), the mediation server 110 automatically generates listed commodity information based on the purchase information and transmits it to the user terminal 120.

### BACKGROUND OF THE INVENTION

### Field of the Invention

The present disclosure relates to an information processing method, an information processing apparatus and a computer-readable non-transitory storage medium storing a program.

### Description of the Related Art

Recently, new settlement services for performing cashless settlement using a smartphone or the like (hereinafter generically referred to as “smartphone settlement”) have rapidly spread.

In a settlement terminal of a shop that permits smartphone settlement, a dedicated settlement application is installed. Prior to using smartphone settlement, a user installs the application for settlement into his own smartphone, inputs required items such as his name, bank account number, credit card number and the like to open an account. For example, by charging (depositing) a predetermined amount of money to the opened account via a bank account, the user is enabled to purchase a commodity at a member shop where smartphone settlement is available.

By the way, it is not clear how a commodity handed to a user by smartphone settlement has been treated afterward. Especially, recently, services for mediating sale/purchase of a commodity via a network between a user who wants to sell the commodity and a user who wants to purchase the commodity (hereinafter referred to as “electronic commerce platforms” for convenience) have spread. By using such a service, a user may be an seller and list/sell a commodity that the user does not use any more or does not like through the service (see, for example Japanese Patent Laid-Open No. 2017-134767).

In order to list a commodity using an electronic commerce platform, a user is required first to start a dedicated application installed in his own terminal (such as a smartphone) and input explanatory comments about the commodity such as a commodity name, a size of the commodity, a state of the commodity and a selling price together with a picture of the commodity. Since such troublesome work occurs, there is a problem that, in some cases, a user does not positively use an electronic commerce platform himself to list a commodity and gives up listing the commodity.

### SUMMARY OF THE INVENTION

An object of an aspect of the present disclosure is to provide an information processing method in which it is possible to use an electronic commerce platform by work that is simpler than conventional work, an information processing apparatus and a program.

An information processing method according to an embodiment of the present disclosure is an information processing method for an information processing apparatus providing an electronic commerce platform where sale/purchase of a commodity via a network is performed between a user who wants to sell the commodity and a user who wants to purchase the commodity, the information processing method including: a reception step of, when any of commodities is purchased at a member shop providing purchase information about the commodities to the information processing apparatus, receiving purchase information about the purchased commodity from an information processing apparatus of the member shop or an information processing apparatus of a user who has purchased the commodity; a generation step of generating listed commodity information for selling the commodity using the electronic commerce platform based on the received purchase information about the commodity; and a display step of causing at least a part of the generated listed commodity information to be displayed on the information processing apparatus of the user.

### BRIEF DESCRIPTION OF THE DRAWINGS

FIG. 1 shows a configuration of a transaction system according to an aspect of an embodiment;

FIG. 2 shows an example of a hardware configuration of an information processing apparatus according to the present disclosure;

FIG. 3 is a schematic flowchart for illustrating an overview of a transaction system according to a first embodiment;

FIG. 4 is a block diagram showing a configuration of a mediation server according to the first embodiment;

FIG. 5 is a diagram illustrating user information registered with a user information database in the mediation server according to the first embodiment;

FIG. 6 is a diagram illustrating purchase information registered with a purchase information database in the mediation server according to the first embodiment;

FIG. 7 is a diagram illustrating listed commodity information about a commodity that is generated by a first generation unit of the mediation server according to the first embodiment;

FIG. 8 is a block diagram showing a configuration of a user terminal according to the first embodiment;

FIG. 9 is a block diagram showing a configuration of a settlement terminal according to the first embodiment;

FIG. 10 shows an example of a sequence of a settlement process of the transaction system according to the first embodiment;

FIG. 11 shows an example of a sequence of a mediation process of the transaction system according to the first embodiment;

FIG. 12 is a diagram showing a configuration of the mediation server according to a first example of the first embodiment;

FIG. 13 is a diagram illustrating registered content of a market price information table in the mediation server according to the first example of the first embodiment;

FIG. 14 is a diagram showing a configuration of the mediation server according to a second example of the first embodiment;

FIG. 15 is a schematic flowchart for illustrating an overview of a transaction system according to a second embodiment;

FIG. 16 is a diagram showing a configuration of a mediation server according to the second embodiment;

FIG. 17 is a diagram illustrating sale/purchase information registered with a sale/purchase information database in the mediation server according to the second embodiment; and

FIG. 18 shows an example of a sequence of an information provision process of the transaction system according to the second embodiment.

### DETAILED DESCRIPTION OF THE PREFERRED EMBODIMENTS

### Compliance

When being implemented, the disclosure described in the present specification is implemented in compliance with laws and ordinances of each country where the present disclosure is implemented. Further, the disclosure described in the present specification is implemented by making all changes, substitutions, variations, alterations and modifications one skilled in the art can make, which are necessary to comply with the laws and ordinances of each country.

Embodiments for implementing a transaction system according to the present disclosure will be described with reference to drawings.

### System Configuration

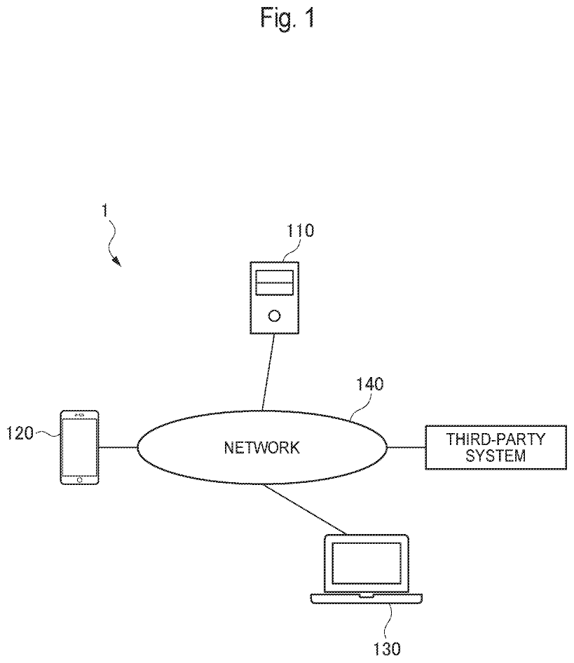

FIG. 1 shows a configuration of a transaction system 1 according to an embodiment of the present disclosure. As disclosed in FIG. 1, in the transaction system 1, a mediation server 110, a user terminal 120 and a settlement terminal 130 are connected via a network 140.

Though only one mediation server 110, only one user terminal 120 and only one settlement terminal 130 are shown in FIG. 1 in the present disclosure, the transaction system 1 may be configured with a plurality of mediation servers 110, user terminals 120 and settlement terminals 130.

If it is not necessary to distinguish the mediation server 110, the user terminal 120 and the settlement terminal 130 from one another in the present disclosure, each of the mediation server 110, the user terminal 120 and the settlement terminal 130 may be expressed as an information processing apparatus 200. The number of information processing apparatuses 200 connected to the network 140 is not limited.

The mediation server 110 is a server that provides an electronic commerce platform. The mediation server 110 accepts listing a commodity from a user, discloses information about the listed commodity via the network 140, and accepts an application for purchase of the listed commodity from a user who wants to purchase the commodity. Further, the mediation server 110 provides process, functions and/or method required for common electronic commerce services. The listing includes listing the product or a service in a certain event

The network 140 is responsible for connecting two or more information processing apparatuses 200. The network 140 means a communication network that provides a connection route so that the user terminal 120 or the settlement terminal 130 can transmit/receive data after connecting to the mediation server 110.

One or more parts of the network 140 may be wired networks or wireless networks. As the network 140, as non-limiting examples, an ad hoc network, intranet, extranet, VPN (virtual private network), LAN (local area network), WLAN (wireless LAN), WAN (wide area network), WWAN (wireless WAN), MAN (metropolitan area network), a part of the Internet, a part of PSTN (public switched telephone network), mobile phone network, ISDN (integrated service digital network), wireless LAN, LTE (long term evolution), CDMA (code division multiple access), Bluetooth (registered trademark), satellite communication or the like, or a combination of two or more of these can be included. The network 140 can include one or more networks 140.

The information processing apparatus 200 may be any information processing apparatus that can realize process, functions and/or method described in the present disclosure.

As the information processing apparatus 200, as non-limiting examples, a smartphone, a mobile phone (feature phone), a computer (such as, as non-limiting examples, a desktop, a laptop and a tablet), a server apparatus, a media computer platform (a cable, a satellite set top box, a digital video recorder or the like, as non-limiting examples), a handheld computer device (PDA (personal digital assistant), an e-mail client and the like, as non-limiting examples), a wearable terminal (a glasses-type device, a watch-type device and the like, as non-limiting examples), another kind of computer, and a communication plat form are included.

### HW (Hardware) Configuration

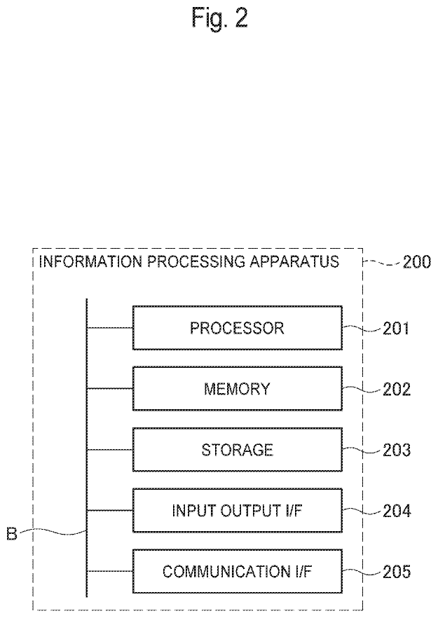

An HW configuration of the information processing apparatus 200 included in the transaction system 1 will be described with reference to FIG. 2.

The information processing apparatus 200 includes a processor 201, a memory 202, a storage 203, an input/output interface (input/output IF) 204 and a communication interface (communication I/F) 205. The components of the HW of the information processing apparatus 200 are mutually connected via a bus B as a non-limiting example.

The information processing apparatus 200 realizes the process, functions and/or method described in the present disclosure by cooperation among the processor 201, the memory 202, the storage 203, the input/output IF 204 and the communication I/F 205.

The processor 201 executes process, functions and/or method realized by codes or instructions included in a program P stored in the storage 203. The processor 201 includes a CPU (central processing unit), an MPU (micro processing unit), a GPU (graphics processing unit), a microprocessor, a processor core, a multi-processor, an ASIC (application-specific integrated circuit), an FPGA (field programmable gate array) and the like as non-limiting examples, and each process disclosed in each embodiment may be realized by a logical circuit (hardware) or a dedicated circuit formed by an IC (integrated circuit) chip, an LSI (large-scale integration) or the like. Each of these circuits may be realized by one or more integrated circuits, and a plurality of processes shown in each embodiment may be realized by one integrated circuit. Further, the LSI may be called a VLSI, a super LSI, an ultra LSI or the like according to difference in the degree of integration.

The memory 202 temporarily stores the program P loaded from the storage 203 and provides a work area for the processor 201. In the memory 202, various kinds of data generated while the processor 201 is executing the program P are also temporarily stored. The memory 202 includes a RAM (random access memory), a ROM (read-only memory) and the like as non-limiting examples.

The storage 203 stores the program P. As the memory 203, an HDD (hard disk drive), an SSD (solid state drive), a flash memory and the like are included as non-limiting examples.

The communication I/F 205 performs transmission/reception of various kinds of data via the network 140. The communication may be wiredly or wirelessly executed. Any communication protocol may be used if mutual communication can be executed. The communication I/F 205 executes communication with another information communication apparatuses via the network 140. The communication I/F 205 transmits various kinds of data to another information processing apparatuses according to an instruction from the processor 201. Further, the communication I/F 205 receives various kinds of data transmitted from another information processing apparatus and communicates the various kinds of data to the processor 201.

The input/output IF 204 includes an input device that inputs various kinds of operations to the information processing apparatus 200 and an output device that outputs a processing result of processing by the information processing apparatus 200. The input/output IF 204 may be such that the input device and the output device are integrated or such that is separated in the input device and the output device.

The input device is realized by any of or a combination of all kinds of devices capable of accepting an input from a user and communicating information related to the input to the processor 201. As the input device, a touch panel, a touch display, hardware keys such as a keyboard, a pointing device such as a mouse, a camera (an operation input by an image) and a microphone (an operation input by voice) are included as non-limiting examples.

The output device is realized by any of or a combination of all kinds of devices capable of outputting a processing result of processing by the processor 201. In the case of outputting the processing result as video and/or a moving image, the output device is realized by any of or a combination of all kinds of devices capable of, according to display data written to a frame buffer, displaying the display data. As the output device, a touch panel, a touch display, a monitor (a liquid crystal display, an GELD (organic electroluminescence display) and the like as non-limiting examples), an HDM (head mounted display), projection mapping, a hologram, a device capable of displaying an image, text information and the like in the air or the like (or in vacuum), a speaker (voice output), a printer and the like are included as non-limiting examples. These output devices may be capable of displaying display data in 3D.

The program P of each embodiment of the present disclosure may be provided in a state of being stored in a computer-readable storage medium. The storage medium is a “non-transitory tangible medium” in which a program can be stored. As the program P, a software program and a computer program are included as non-limiting examples.

As the storage medium, one or more semiconductor-based or other ICs (integrated circuits) (an FPGA (field programmable gate array), an ASIC (application-specific IC) and the like as non-limiting examples), an HDD (hard disk drive), an HHD (hybrid hard drive), an optical disk, an ODD (optical disk drive), a magneto-optical disk, a magneto-optical drive, a floppy diskette, an FDD (floppy disk drive), a magnetic tape, an SSD (solid state drive), a RAM drive, a secure digital card or drive, any other appropriate storage medium, and an appropriate combination of two or more of the above can be included if appropriate. The storage medium may be volatile, nonvolatile or a combination of volatile and nonvolatile media if appropriate.

The program P of the present disclosure may be provided for the information processing apparatus 200 via any transmission medium (a network, a broadcast wave or the like) capable of transmitting the program.

The program P of the present disclosure is implemented in a script language such as ActionScript and JavaScript (registered trademark), an object-oriented programming language such as Objective-C and Java (registered trademark), a markup language such as HTML5, or the like as non-limiting examples.

At least a part of processes in the information processing apparatus 200 may be realized by cloud computing configured with one or more computers.

A configuration is also possible in which at least a part of the processes in the information processing apparatus 200 are performed by another information processing apparatus. In this case, a configuration is also possible in which at least a part of a process of each unit realized by the processor 201 is performed by the other information processing apparatus.

### Others

Unless explicitly stated, a configuration for judgment in the embodiments of the present disclosure is not essential. A predetermined process may be performed when a judgment condition is satisfied, or a predetermined process may be performed when a judgment conditions is not satisfied.

In the present disclosure, “or” is assumed to have not an exclusive meaning but an inclusive meaning unless explicitly otherwise described or unless otherwise suggested by context. Therefore, in the present disclosure, “A or B” means “A, B, or both of them” unless explicitly otherwise described or unless otherwise suggested by context. Furthermore, “and” has both meanings of cooperation (joint) and individual (several) unless explicitly otherwise described or unless otherwise suggested by context. Therefore, in the present specification, “A and B” means “A and B, jointly or severally” unless explicitly otherwise described or unless otherwise suggested by context. Furthermore, it is assumed that “a”, “an” or “the” means “one or more” unless explicitly otherwise described or unless otherwise suggested by context. Therefore, in the present specification, “an A” or “the A” means “one or more A's” unless explicitly otherwise described or unless otherwise suggested by context.

The present disclosure includes all the changes, substitutions, variations, alterations and modifications that one skilled in the art can make in the embodiments and/or examples of the present disclosure. Similarly, if appropriate, the accompanying claims include all the changes, substitutions, variations, alterations and modifications that one skilled in the art can make in the embodiments and/or examples of the present disclosure. Furthermore, the present disclosure includes any combination between one or more characteristics of an embodiment or example of the present disclosure and one or more characteristics of another embodiment or example of the present disclosure that one skilled in the art can make.

In addition, in referring to an apparatus or a system, or a component of an apparatus or a system, which is adapted, arranged, provided with a capability, configured, usable, operable or capable of operating so as to perform a particular function, within the accompanying claims, the apparatus, the system or the component is included irrespective of whether the apparatus, the system, the component or the particular function thereof is activated, turned on or lock-released as far as the apparatus, the system or the component is adapted, arranged, provided with the capability, configured, usable, operable or capable of operating so.

### First Embodiment

### (Overview)

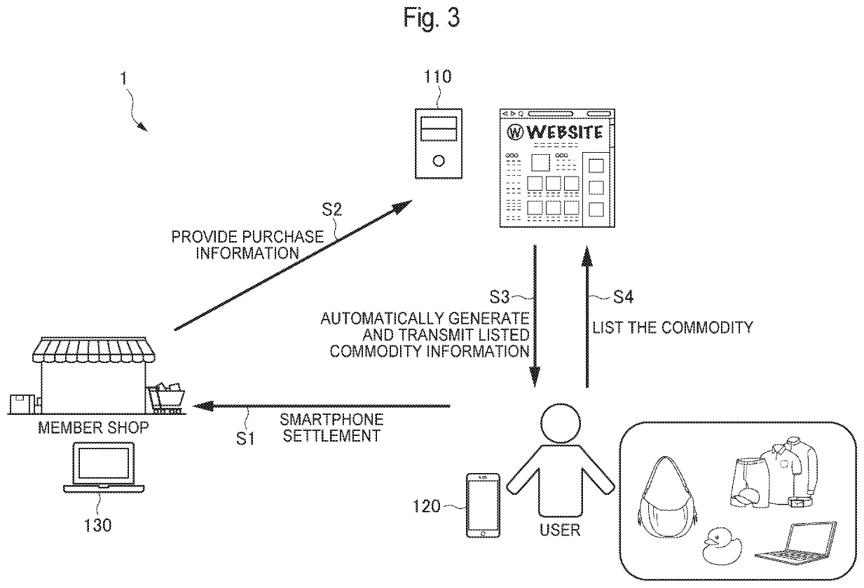

FIG. 3 is a schematic flowchart for illustrating an overview of the transaction system 1 according to a first embodiment.

First, when finding a desired commodity at a member shop, a user performs smartphone settlement using the user terminal 120 to purchase the commodity (step S1).

Meanwhile, the settlement terminal 130 of the member shop generates purchase information about the commodity the user has purchased, being triggered by the smartphone settlement. The purchase information may include information such as the member shop where the commodity has been purchased, a user ID identifying the user who has purchased the commodity, a commodity name of the purchased commodity, a purchase date and time and a purchase price (to be described in detail later). The “member shop” means a shop or user permitting provision of the purchase information about a commodity purchased at the shop for the mediation server 110. The settlement terminal 130 transmits the generated purchase information to the mediation server 110 (step S2).

When receiving the purchase information, the mediation server 110 records the received purchase information to a database according to the user ID. After that, when receiving, from the user terminal 120, a notification to the effect that the user wants to list the commodity purchased at the member shop on an electronic commerce platform (application for sale), the mediation server 110 automatically generates listed commodity information based on the purchase information recorded in the database and transmits it to the user terminal 120 (step S3). The listed commodity information may include information specific to the commodity, such as the commodity name, size, price and purchase price of the commodity, use period information indicating a period of use of the commodity (for example, elapse of 3 months after purchase), recommended sale price information indicating a recommended sale price, explanatory comments about the commodity and the like (to be described in detail later).

The user creates formal listed commodity information about the commodity based on the listed commodity information transmitted from the mediation server 110, and lists the commodity on the electronic commerce platform (step S4).

### (Effects)

Thus, according to the first embodiment, listed commodity information is automatically generated in the mediation server 110 when a commodity is listed on the electronic commerce platform. Therefore, a user is not required to create listed commodity information from the beginning, and it becomes possible for the user to list a commodity on the electronic commerce platform by a simple operation of appropriately editing listed commodity information.

### Configuration of First Embodiment

A configuration of each of the mediation server 110, the user terminal 120 and the settlement terminal 130 according to the first embodiment will be described. Each unit of the mediation server 110, the user terminal 120 and the settlement terminal 130 are realized in cooperation among the processor 201, the memory 202, the storage 203, the input/output IF 204 and the communication I/F 205 that each information processing apparatus 200 is provided with.

### (1) Configuration of Mediation Server 110

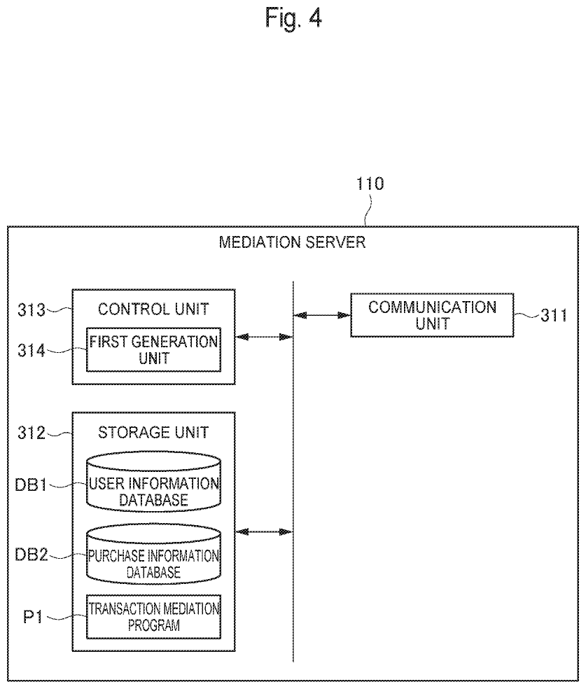

FIG. 4 is a block diagram showing the configuration of the mediation server 110.

The mediation server 110 has a communication unit 311, a storage unit 312, a control unit 313 and a first generation unit 314.

The communication unit 311 is configured with the communication I/F 205 and the like and performs giving and receiving of various information to and from the user terminal 120 and the settlement terminal 130.

The storage unit 312 is configured with the memory 202 and the like and stores a user information database DB1, a purchase information database DB2, a transaction mediation program P1 and the like.

User information about each user permitted to use the electronic commerce platform is registered with the user information database DB1.

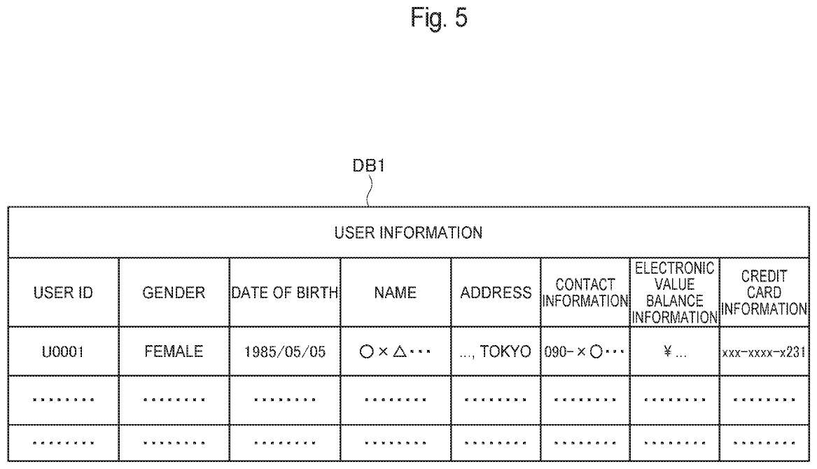

FIG. 5 is a diagram illustrating the user information registered with the user information database DB1.

As shown in FIG. 5, each piece of user information may include, in addition to a user ID for identifying a user, gender, date of birth, name, address, contact information and the like, electronic value balance information, credit card information and the like. The electronic value balance information is information indicating balance of electronic money, and the credit information is a credit card number or the like the user uses for settlement. The user information includes, as non-limiting examples, information associated with the user, such as the user's name, an icon image of the user, the user's age, the user's gender, the user's address, the user's hobbies and tastes, and an identifier of the user, that is inputted by the user or given by a predetermined service, and the user information may be any one of or a combination of these.

Purchase information transmitted from the settlement terminal 130 of each member shop is registered with the purchase information database DB2. The purchase information is information indicating details of a commodity purchased by each user as described above.

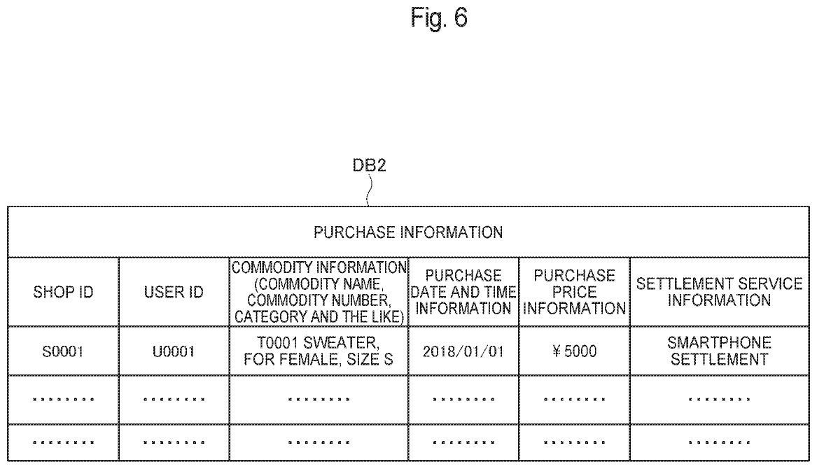

FIG. 6 is a diagram illustrating the user information registered with the purchase information database DB2.

As shown in FIG. 6, each piece of purchase information may include a shop ID (identification information) for identifying a member shop, which is a purchase place of a commodity, a user ID (identification information) for identifying a user who purchased the commodity, commodity information indicating a commodity name, a commodity number, a category and the like of the purchased commodity, purchase date and time information indicating a purchase date and time, purchase price information indicating a purchase price, settlement service information indicating a settlement method, and the like. In the example in FIG. 6, it is shown that, at a shop with a shop ID “S0001”, a user with a user ID “U0001” purchased a commodity indicated by commodity information “T0001, sweater, for women, size S” at a date and time of “2018/01/01” indicated by purchase date and time information at a price “¥5000” indicated by purchase price information, and that the settlement method at that time was a settlement service of “smartphone settlement”. The purchase information may include a commodity ID (such as a model number) instead of detailed information such as the commodity information, the purchase date and time information, the purchase price information and the settlement information. In the case where the commodity ID is included in the purchase information, the detailed information such as the commodity information, the purchase date and time information, the purchase price information and the settlement information may be acquired from a selling agency that sells the commodity.

The transaction mediation program P1 is a program for realizing the electronic commerce platform by the mediation server 110 and is executed by the control unit 313.

In addition, the storage unit 312 stores a commodity information database with which information about listed commodities is registered, a history database in which results of sale/purchase on the electronic commerce platform performed in the past via the mediation server 110 are recorded, and the like.

The control unit 313 is configured with the processor 201 and the like. By executing the transaction mediation program P1 and the like, the control unit 313 centrally controls each unit of the mediation server 110 and realizes process and/or functions and the like of the first generation unit 314.

When a user lists a commodity that the user purchased at a member shop on the electronic commerce platform, the first generation unit 314 automatically generates listed commodity information based on purchase information registered with the purchase information database DB2.

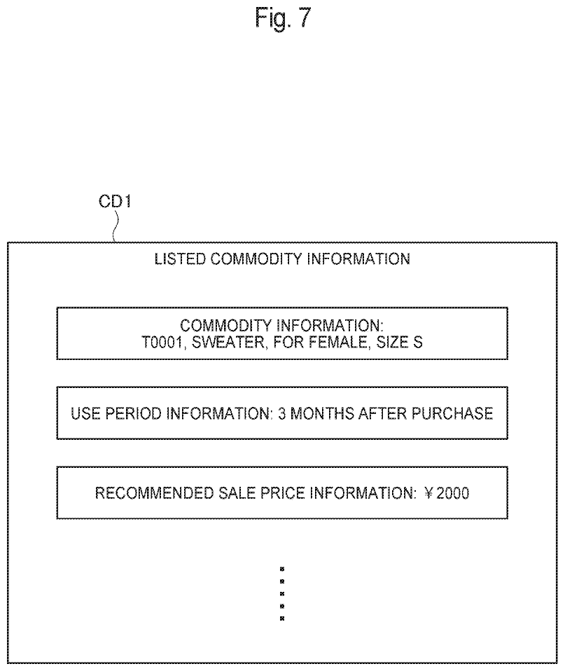

FIG. 7 is a diagram illustrating listed commodity information CD1 about a commodity that is generated by the first generation unit 314.

As shown in FIG. 7, the listed commodity information CD1 may include commodity information about an listed commodity, use period information indicating the number of days elapsed after purchase, recommended sale price information indicating a recommended sale price of the listed commodity, and the like. In the example shown in FIG. 7, it is shown as the listed commodity information CD1 that the commodity is a commodity indicated by “T0001, sweater, for women, size S” (the commodity information), that the use period is “3 months after purchase” (the use period information) and that the recommended sale price is “¥2000” (the recommended sale price information). The use period can be determined, for example, by counting the number of days from the purchase date and time indicated by the purchase date and time information until the current point of time. In the case of deciding the recommended sale price, for example, a quality state of the commodity (for example, “Rank 1 (brand-new)”, “Rank 2 (almost unused)”, “Rank 3 (slightly used feeling)”, “Rank 4 (much used feeling)” and the like) may be estimated based on the purchase date and time information and the like to reflect the estimated quality state on the recommended sale price. Otherwise, the recommended sale price may be decided based on secondary distribution market prices. As a non-limiting example, based on information included in the commodity information, the recommended sale price is decided based on listing prices and successful bid prices (prices when sale/purchase is actually decided) of similar secondary distribution commodities (this will be described later in a first example). The use period and the method for determining the recommended sale prices are merely examples, and what method is to be adopted can be appropriately set and changed.

When having automatically generated the listed commodity information CD1, the first generation unit 314 sends it to the communication unit 311. When receiving the listed commodity information CD1 from the first generation unit 314, the communication unit 311 transmits it to the user terminal 120.

### (2) Configuration of User Terminal 120

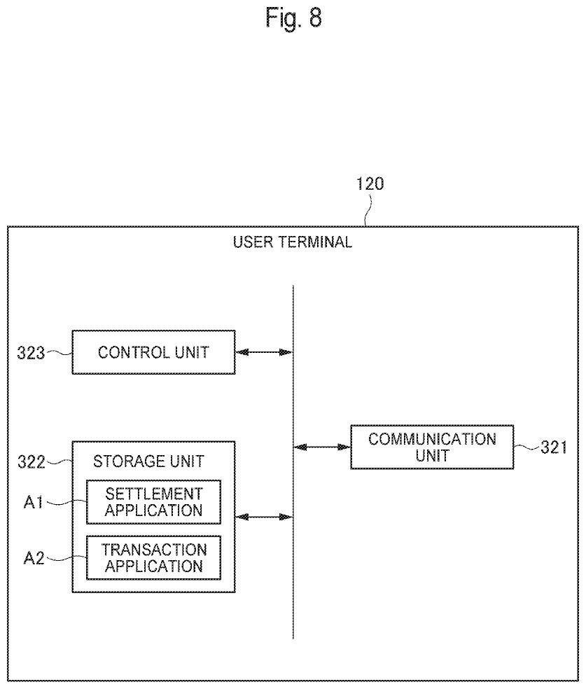

FIG. 8 is a block diagram showing the configuration of the user terminal 120.

The user terminal 120 is a terminal used by a user and has a communication unit 321, a storage unit 322 and a control unit 323.

The communication unit 321 is configured with the communication I/F 205 and the like and performs giving and receiving of various information to and from the mediation server 110 and the settlement terminal 130.

The storage unit 322 is configured with the memory 202 and the like and stores a settlement application A1, a transaction application A2 and the like. The settlement application A1 is, for example, an application for smartphone settlement and is used when the user purchases a desired commodity at a member shop. Naturally, instead of the settlement application A1 and the transaction application 2A, one application may be configured to make a settlement and a transaction.

The transaction application A2 is an application for using the electronic commerce platform and is used at the time of listing a commodity or purchasing an listed commodity.

The control unit 323 is configured with the processor 201 and the like. The control unit 323 centrally controls each unit of the user terminal 120 by activating various kinds of programs and data stored in the storage unit 322.

### (3) Configuration of Settlement Terminal 130

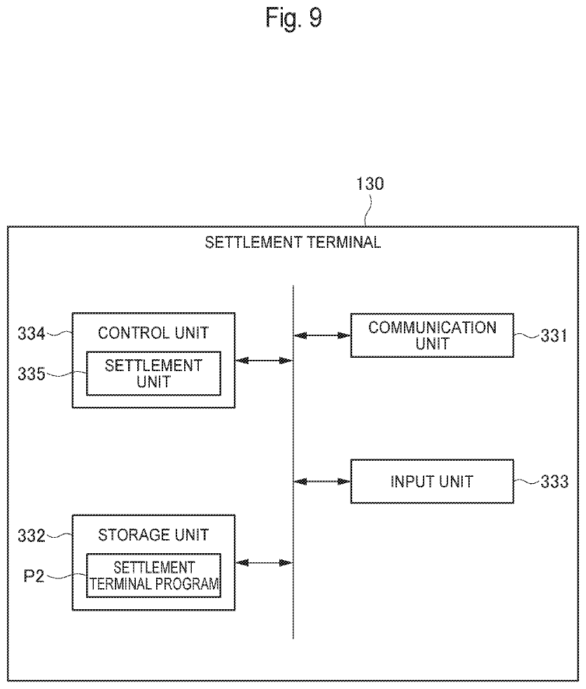

FIG. 9 is a block diagram showing the configuration of the settlement terminal 130.

The settlement terminal 130 is a terminal such as a POS register installed at each member shop, and has a communication unit 331, a storage unit 332, an input unit 333, a control unit 334 and a settlement unit 335.

The communication unit 331 is configured with the communication I/F 205 and the like and performs giving and receiving of various information to and from the mediation server 110 and the user terminal 120.

The storage unit 332 is configured with the memory 202 and the like and stores a settlement terminal program P2 and the like. The settlement terminal program P2 is a program for settlement terminal that enables acceptance of smartphone settlement.

The input unit 333 is configured with the input/output IF 204, a reader terminal and the like. The input unit 333 inputs information for smartphone settlement (for example, a QR code) from the user terminal 120.

The control unit 334 is configured with the processor 201 and the like. By executing the settlement terminal program P2 and the like, the control unit 334 centrally controls each unit of the settlement terminal 130 and realizes process and/or functions and the like of the settlement unit 335.

The settlement unit 335 executes smartphone settlement according to a request from a user and generates purchase information under control of the control unit 334. As already described, the purchase information may include a shop ID, a user ID, commodity information, purchase date and time information, purchase price information, settlement service information and the like (see FIG. 6).

When having generated the purchase information, the settlement unit 335 sends it to the communication unit 331. When receiving the purchase information from the settlement unit 335, the communication unit 331 transmits it to the mediation server 110.

### Settlement Process of First Embodiment

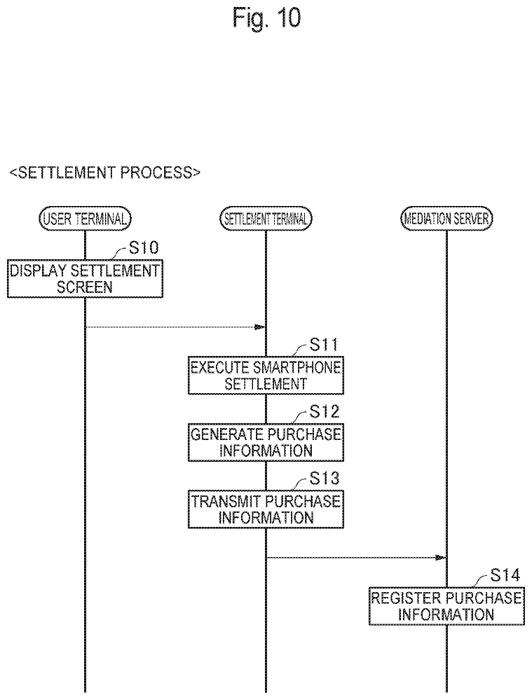

A settlement process of the transaction system 1 according to the first embodiment will be described with reference to FIG. 10. FIG. 10 shows an example of a sequence of the settlement process of the transaction system 1 according to the first embodiment. In the description below, a case is assumed where sufficient electronic value is deposited in an account for settlement.

When the user finds a desired commodity at a member shop, the user operates the user terminal 120 to activate the settlement application A1, brings the commodity to the settlement terminal 130 and displays a settlement screen on a display of the user terminal 120 (step S10). A staff member or the like of the member shop operates the settlement terminal 130 to read a tag of the commodity and the settlement screen (a QR code or the like) displayed on the display of the user terminal 120. When such an operation is performed, the settlement unit 335 of the settlement terminal 130 executes smartphone settlement (step S11). When the smartphone settlement is normally performed, the settlement unit 335 generates information showing details of the commodity that the user has purchased (that is, purchase information) (step S12) and sends it to the communication unit 331. If the smartphone settlement is not normally performed, the settlement unit 335 displays an error message or the like on the display of the user terminal 120 to prompt the user to perform smartphone settlement again. The settlement unit 335 may prompt the user to perform another settlement method (for example, cash settlement, card settlement or the like). Otherwise, without intervention of the settlement terminal 130, the tag (the QR code or the like) of the commodity may be read by the user terminal 120, and purchase information may be generated on the user terminal 120 and transmitted to the mediation server 110.

The communication unit 331 of the settlement terminal 130 transmits the purchase information about the user generated by the settlement unit 335 to the mediation server 110 (Step S13). When receiving the purchase information about the user, the control unit 313 of the mediation server 110 registers it with the purchase information database DB2 (step S14).

### Mediation Process of First Embodiment

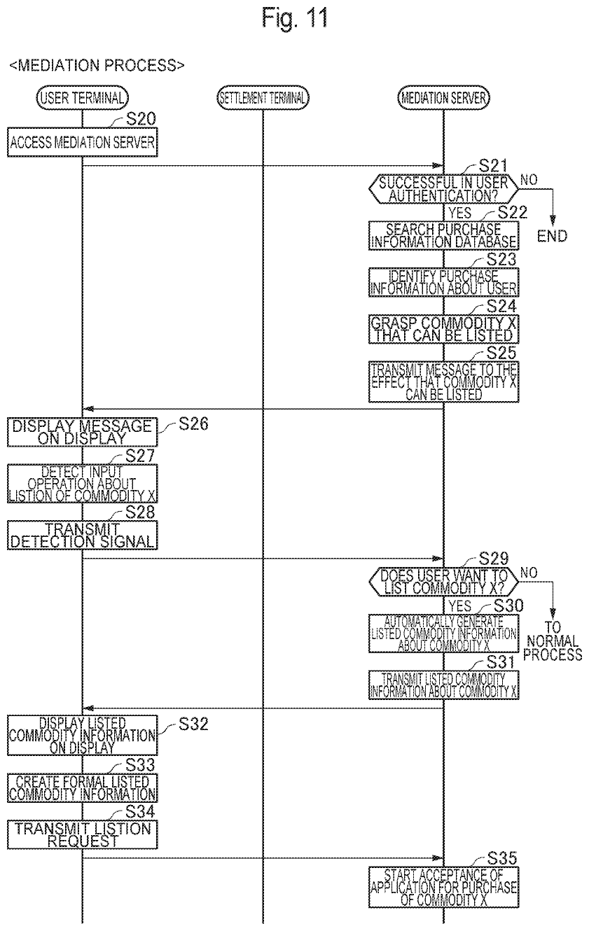

Next, a mediation process of the transaction system 1 according to the first embodiment will be described with reference to FIG. 11. FIG. 11 shows an example of a sequence of the mediation process of the transaction system 1 according to the first embodiment.

When the user operates the user terminal 120 to activate the transaction application A2 and access the mediation server 110 (step S20), the control unit 313 of the mediation server 110 performs user authentication first (step S21). For example, if the control unit 313 of the mediation server 110 judges that the authentication has failed because a user ID inputted by the user does not correspond to any of user IDs registered with the user information database DB1 (step S21: NO), the control unit 313 ends the process, for example, by returning an error message or the like to the user terminal 120.

On the other hand, if the control unit 313 of the mediation server 110 judges that the authentication is successful because the user ID inputted by the user corresponds to any of the user IDs registered with the user information database DB1 (step S21: YES), the control unit 313 searches the purchase information database DB2 with the user ID as a search key (step S22).

The control unit 313 of the mediation server 110 identifies a piece of purchase information the user ID of which corresponds, from among pieces of purchase information registered with the purchase information database DB2 (step S23) and identifies that there is a commodity that was purchased at a member shop and can be listed (step S24). To make a description on FIG. 6 as an example, it is identified that, for example, in the case of the user with the user ID “U0001”, the commodity indicated by the commodity information “T0001, sweater, for women, size S” is a commodity that can be listed. Hereinafter, a commodity that can be listed will be called a commodity X.

Based on the identification result, the control unit 313 of the mediation server 110 returns a message to the effect that the commodity X purchased at a member shop can be listed (for example, “Thank you for use, Miss xxxxx. The commodity X purchased at a member shop can be listed at present. Do you want to list it?”) to the user terminal 120 (step S25). The control unit 323 of the user terminal 120 displays the message received from the mediation server 110 on the display (step S26). The user confirms the message displayed on the display and performs an input operation to the effect that the user wants to or does not want to list the commodity X. Here, if there are a plurality of commodities X that can be listed, these commodities may be displayed in a list. Furthermore, only such commodities that match a predetermined condition (for example, commodities purchased at shops within the past one year).

When detecting the input operation to the effect that the user wants to or does not want to list the commodity X (step S27), the control unit 323 of the user terminal 120 transmits a detection signal indicating a detection result to the mediation server 110 (step S28).

The control unit 313 of the mediation server 110 judges whether the user wants to or does not want to list the commodity X based on the detection signal transmitted from the user terminal 120 (step S29). If judging that the user wants to list the commodity X (step S29: YES), the control unit 313 of the mediation server 110 sends an instruction to create listed commodity information about the commodity X to the first generation unit 314. On the other hand, if judging that the user does not want to list the commodity X (step S29: NO), the control unit 313 of the mediation server 110 performs a normal process (for example, a process for accepting listing another commodity).

Based on the instruction of the control unit 313, the first generation unit 314 of the mediation server 110 creates listed commodity information about the commodity X, for example, as shown in FIG. 7 based on the matched purchase information (step S30). As described before, the listed commodity information may include commodity information about the listed commodity X, use period information indicating the number of days elapsed after purchase, recommended sale price information indicating a recommended sale price of the listed commodity X, and the like.

When having automatically generated the listed commodity information about the commodity X, the first generation unit 314 of the mediation server 110 sends it to the communication unit 311. The communication unit 311 of the mediation server 110 transmits the generated listed commodity information about the commodity X to the user terminal 120 (step S31).

When receiving the listed commodity information about the commodity X from the mediation server 110, the control unit 323 of the user terminal 120 displays it on the display (step S32). The user appropriately edits the listed commodity information displayed on the display. The control unit 323 of the user terminal 120 creates formal listed commodity information about the commodity X according to the editing operation of the listed commodity information by the user (step S33).

Information about change due to use of the user may be described in the listed commodity information. The listed commodity information may additionally include, as non-limiting examples, a message indicating use frequency of the commodity X (“used only several times so far” or the like), a message indicating presence/absence of damage or dirt on the commodity X (for example, “there is a tear on the right corner” or the like), a picture of a particular position (a position where dirt is noticeable) of the commodity X.

When having created the listed commodity information about the commodity X, the user operates the user terminal 120 to input an listing request including the listed commodity information about the commodity X. When receiving the listing request, the control unit 323 of the user terminal 120 transmits it to the mediation server 110 (step S34). When receiving the listing request, the control unit 313 of the mediation server 110 publishes the listed commodity information about the commodity X and starts acceptance of application for purchase of the listed commodity X (step S35).

Though an aspect has been exemplified in the above first embodiment in which, at step S2, settlement of purchase of a commodity at a member shop is performed on the settlement terminal 130, and purchase information is transmitted from the settlement terminal 130 to the mediation server 110, the present disclosure is not limited thereto. As non-limiting examples, in the case of performing smartphone settlement at a self-cash register, a tag of a commodity may be read by the user terminal 120 to generate purchase information on the user terminal 120, and the purchase information may be transmitted to the mediation server 110; and, in the case of reading a two-dimensional code prepared at a shop by the user terminal 120 to perform settlement, purchase information may be generated on the user terminal 120 and transmitted to the mediation server 110.

Though an aspect has been exemplified in the above first embodiment in which, when the mediation server 110 receives purchase information about a user, the mediation server 110 registers the purchase information with the purchase information database DB2 at step S14, the present disclosure is not limited thereto. As a non-limiting example, the user terminal 120 may register the purchase information about the user.

### First Example

In a first example, a recommended sale price of an listed commodity is determined using market prices of the commodity. By using the market prices of the commodity, it is possible to set a recommended sale price to a reasonable price on which the market is reflected.

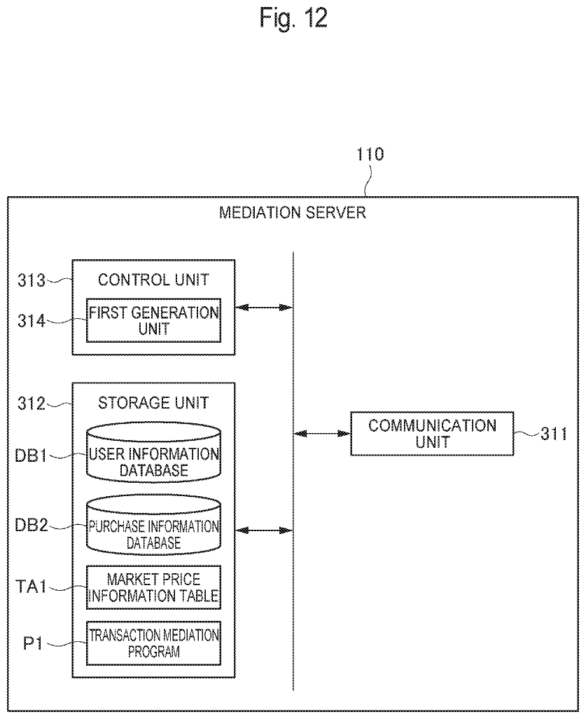

FIG. 12 is a diagram showing a configuration of the mediation server 110 according to the first example. The mediation server 110 according to the first example is the mediation server 110 shown in FIG. 4 in which a market price information table TA1 is provided. Since other components are similar to those of the mediation server 110 shown in FIG. 4, corresponding parts will be given the same reference symbols, and detailed description of the parts will be omitted.

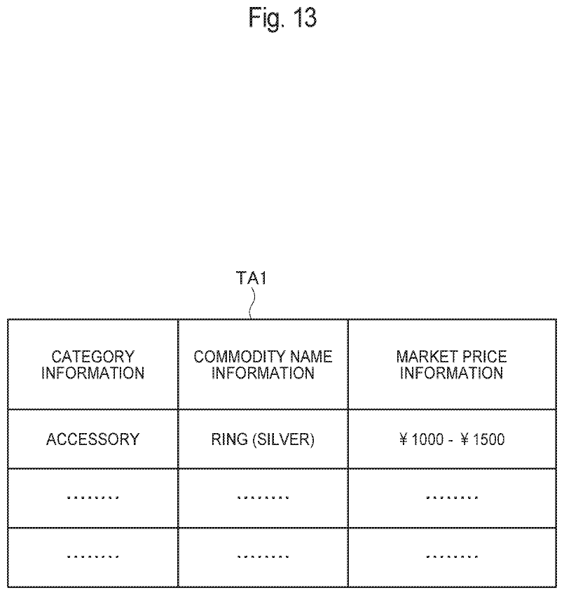

The market price information table TA1 is a management table created based on the results of sale/purchase of the electronic commerce platform. FIG. 13 is a diagram illustrating registered content of the market price information table TA1. Category information showing a commodity category, commodity name information showing a commodity name, market price information indicating market prices are registered with the market price information table TA1 in association with one another. In the example shown in FIG. 13, it is shown that, as for a commodity indicated by commodity name information “ring (silver)” belonging to category information “accessory”, market prices are “¥1000-¥1500” indicated as market price information.

At the time of determining a recommended sale price, the first generation unit 314 of the mediation server 110 searches the market price information table TA1 with commodity information (for example, a commodity name) about a commodity included in purchase information as a search key. For example, if the commodity name of the commodity included in the purchase information is “ring (silver)”, the first generation unit 314 acquires the market price information “¥1000-¥1500” corresponding to the commodity name from the market price information table TA1 and sets the market prices shown by the acquired market price information as the recommended sale price.

Though a case where market prices of a commodity are determined based on the transaction results of the electronic commerce platform is exemplified in the above example, it is not intended to limit the present disclosure thereto. For example, market price information showing market prices of each commodity may be acquired from a third party operating the same kind of electronic commerce platform to determine market prices of a commodity using the acquired market price information.

If there is not a commodity having a corresponding commodity name in the market price information table TA1, the recommend sale price may be estimated based on market prices of a similar commodity or another commodity belonging to the same category.

As for the recommended sale price, a user may be able to adjust the recommended sale price by an easy operation. For example, an adjustment bar with a determined recommended sale price set as a middle point is displayed on the display of the user terminal 120. It becomes possible for the user to easily adjust the recommended sale price by appropriately operating the user terminal 120. Thus, by prompting adjustment of a recommended sale price, it is possible to avoid setting of a sale price significantly deviating from market prices.

### Second Example

In a second example, benefit information (an advertisement, a coupon or the like) for prompting use of the electronic commerce platform is provided for a user who has purchased a commodity at a member shop. According to such a configuration, it is possible to give motivation to list a commodity on the electronic commerce platform to the user.

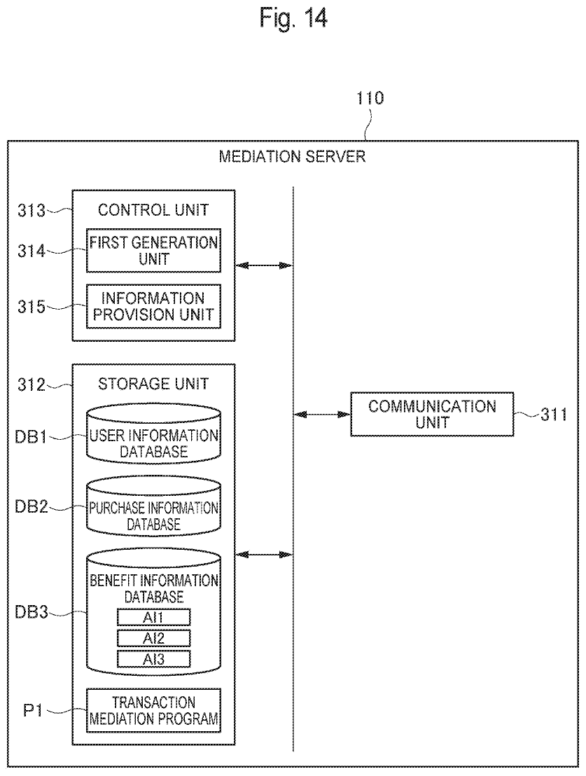

FIG. 14 is a diagram showing a configuration of the mediation server 110 according to the second example. The mediation server 110 according to the second example is the mediation server 110 shown in FIG. 4 in which a benefit information database DB3 and an information provision unit 315 are provided. Since other components are similar to those of the mediation server 110 shown in FIG. 4, corresponding parts will be given the same reference symbols, and detailed description of the parts will be omitted.

In the benefit information database DB3, a plurality of benefit algorithms A11 to A13 to be executed by the information provision unit 315 are stored.

The benefit algorithm A11 is, for example, an algorithm to provide benefit information available (valid) at a member shop where a user purchased a commodity. By executing the benefit algorithm A11, information showing a coupon or an advertisement, for example, “20% off for commodities belonging to the same category (“accessory”) as the commodity (“ring (silver)”) that the user purchased” is generated.

The benefit algorithm A12 is, for example, an algorithm to provide, for example, an appropriate listing timing (benefit information) of a commodity that a user purchased at a member shop. By executing the benefit algorithm A12, information showing a listing timing, for example, “It is recommended to list the commodity (a fur coat) that the user purchased when it gets cold (“from November to December”)” is generated.

The benefit algorithm A13 is an algorithm to provide, for example, a recommended commodity (benefit information) that can be newly purchased by selling a commodity using the electronic commerce platform and getting a sales price (or points). By executing the benefit algorithm A13, information showing a recommended commodity, for example, “An advantageous commodity (“business shoes”) can be purchased if the commodity (“purse”) that the user purchased is listed and sold” is generated.

As for the listing timing, for example, by referring to the history database or the like in which the results of sale/purchase on the electronic commerce platform performed via the mediation server 110 are recorded, a period during which the same commodity was sold at the highest price can be set as the listing timing with reference to a price movement chart and the like of the same commodity. As for the recommended commodity, the recommended commodity can be set in consideration of a user's tastes based on the user's transaction history and the like. Though the three kinds of typical benefit algorithms have been shown in the present example to facilitate understanding of the description, the number of benefit algorithms is not limited. Further, the benefit algorithms A11 to A13 may be, of course, used together.

The information provision unit 315 appropriately selects and executes the benefit algorithms A11 to A13 to provide the benefit information (advertisement, coupons or the like) prompting use of the electronic commerce platform to a user who purchased a commodity at a member shop.

When having selected the benefit algorithm A11, the information provision unit 315 generates benefit information about a coupon or advertisement valid at a member shop where the user purchased a commodity and sends the benefit information to the communication unit 311. The communication unit 311 transmits the benefit information about a coupon or advertisement generated at the information provision unit 315, to the user terminal 120.

### Second Embodiment

### (Summary)

If it is possible for each member shop to grasp whether a commodity sold at the member shop is sold using the electronic commerce platform (that is, whether the commodity is on secondary distribution), it becomes possible to, if the commodity is on secondary distribution, work on a user who lists the commodity to visit the member shop again. However, it is the present situation that there is actually no way for each member shop to grasp whether a commodity sold at the member shop is on secondary distribution or not.

Therefore, an object of an aspect of the present disclosure in a second embodiment may be to provide an information processing method in which a member shop can grasp whether a commodity sold at the member shop is on secondary distribution or not, an information processing apparatus and a computer-readable non-transitory storage medium storing a program.

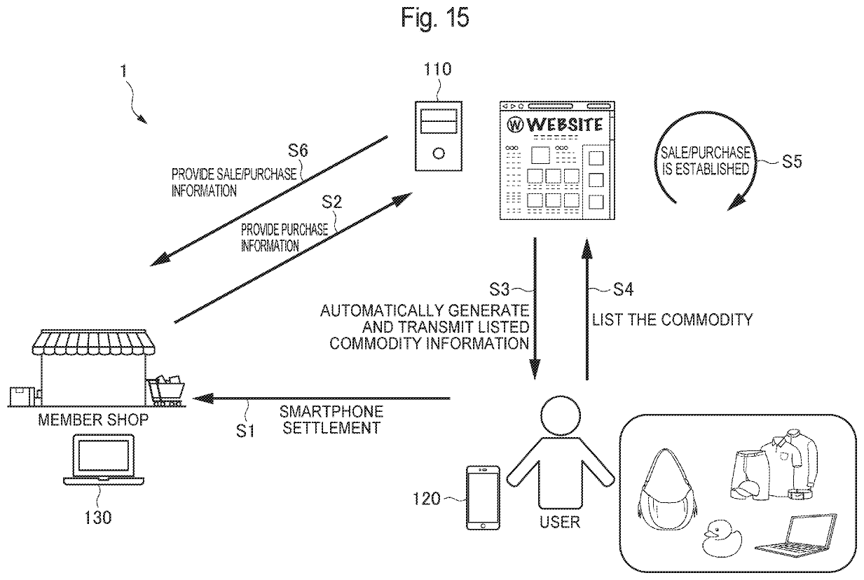

FIG. 15 is a schematic flowchart for illustrating an overview of the transaction system 1 according to the second embodiment. The schematic flowchart shown in FIG. 5 is the schematic flowchart shown in FIG. 3 in which steps S5 and S6 are provided. Since other steps are similar to those of the schematic flowchart shown in FIG. 3, corresponding parts will be given the same reference symbols, and detailed description of the parts will be omitted.

The mediation server 110 accepts listing a commodity from a user, discloses information about the listed commodity via the network 140, and accepts an application for purchase of the listed commodity from a user who wants to purchase the commodity.

When sale/purchase of the listed commodity is established after that (step S5), the mediation server 110 generates sale/purchase information showing content of the sale/purchase, being triggered by the establishment of the sale/purchase. The sale/purchase information may include a shop ID identifying a member shop, which is a purchase place of the commodity, commodity information about the commodity (that is, information indicating a commodity name, a commodity number and a category of the commodity), distribution period information indicating a period from when the commodity was listed to when it was sold, and the like (details will be described later). The mediation server 110 transmits the generated sale/purchase information to the member shop which is the purchase place (step S6).

### (Effects)

Thus, according to the second embodiment, it is possible for an owner or the like of a member shop, which is a purchase place of a commodity, to grasp how long and in what price range the commodity sold at the member shop is listed on the electronic commerce platform and is on secondary distribution, by viewing the received sale/purchase information. It becomes possible for the owner or the like of the member shop to perform effective marketing based on the grasped information.

### Configuration of Second Embodiment

A onfiguration of each of the mediation server 110, the user terminal 120 and the settlement terminal 130 according to the second embodiment will be described. In the description below, components other than the mediation server 110, that is, the user terminal 120 and the settlement terminal 130 are similar to those of the first embodiment.

### (1) Configuration of Mediation Server

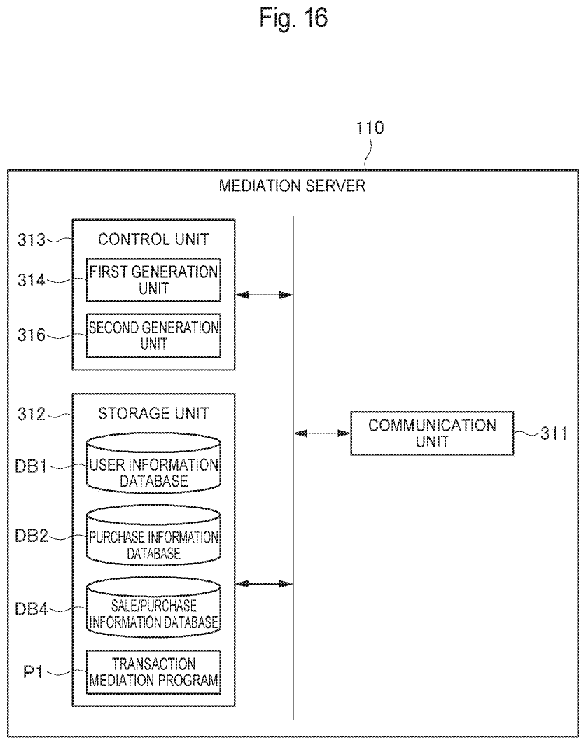

FIG. 16 is a diagram showing the configuration of the mediation server 110 according to the second example. The mediation server 110 is the mediation server 110 shown in FIG. 4 in which a sale/purchase information database DB4 and a second generation unit 316 are provided. Since other components are similar to those of the mediation server 110 shown in FIG. 4, corresponding parts will be given the same reference symbols, and detailed description of the parts will be omitted.

The second generation unit 316 judges whether a commodity sold via the electronic commerce mediation system is a commodity purchased at a member shop (hereinafter referred to as “a commodity via a member shop”) or not. As described above, in the case of a commodity via a member shop, purchase information is already stored in the purchase information database DB2. The second generation unit 316 refers to the purchase information database DB2. If judging that the purchase information is registered, the second generation unit 316 assumes the commodity that has just been sold is a commodity via a member shop and generates sale/purchase information based on the purchase information corresponding to the commodity.

In the sale/purchase information database DB4, sale/purchase information generated by the second generation unit 316 is stored. The sale/purchase information is information indicating details about sale/purchase of a commodity via a member shop.

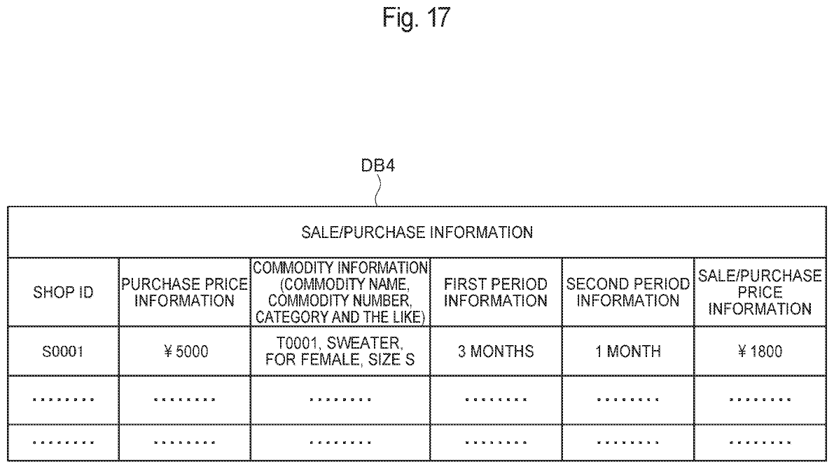

FIG. 17 is a diagram illustrating the sale/purchase information registered with the sale/purchase information database DB4.

As shown in FIG. 17, the sale/purchase information may include a shop ID for identifying a member shop, which is a purchase place of a commodity, commodity information about the commodity (that is, information indicating a commodity name, a commodity number, a category and the like of the commodity), first period information indicating a period until the commodity was listed after the commodity was purchased, second period information indicating a period until sale/purchase was established after the commodity was listed, sale/purchase price information indicating a price when the commodity was actually sold and purchased, and the like.

In the example in FIG. 17, for a commodity indicated by commodity information “T0001, sweater, for female, size S” purchased at a price of “¥5000” indicated by purchase price information at a shop with a shop ID “S0001”, a period from purchase to listing is “3 months” indicated by first period information, and a period from listing to sale is “1 month” indicated by second period information. It is shown that the sale/purchase price at that time is “¥1800” indicated by sale/purchase price information. What information is to be included into the sale/purchase information can be arbitrarily set and changed. For example, information indicating what commodity is often listed and actually sold/purchased on the electronic commerce platform may be included into the sale/purchase information.

When having generated the sale/purchase information based on the purchase information for the commodity via a member shop, the second generation unit 316 stores the sale/purchase information into the sale/purchase information database DB4 and also sends it to the communication unit 311.

When receiving the sale/purchase information about the commodity via a member shop, the communication unit 311 transmits it to the settlement terminal 130 of a corresponding member shop.

### Information Provision Process of Second Embodiment

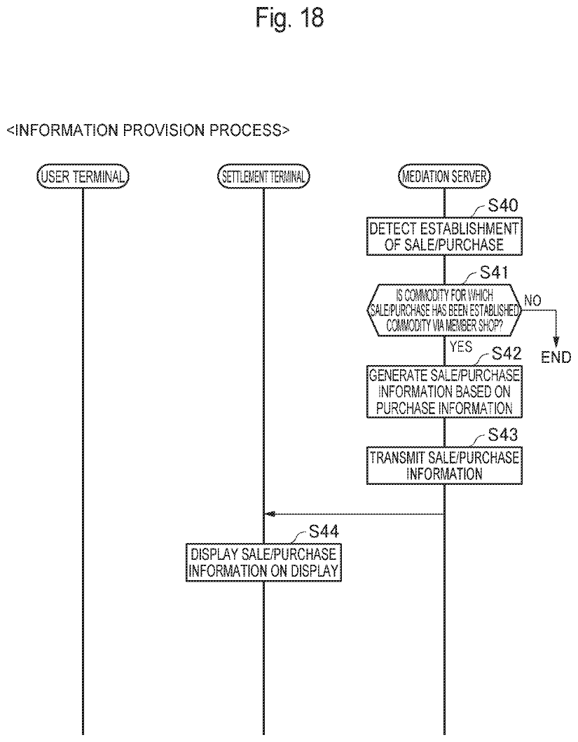

Next, an information provision process of the transaction system 1 according to the second embodiment will be described with reference to FIG. 18. FIG. 18 shows an example of a sequence of the information provision process of the transaction system 1 according to the second embodiment. In the description below, it is assumed that a commodity was listed via the mediation server 110, and sale/purchase with a purchaser has been established.

When establishment of sale/purchase of an listed commodity is detected by the control unit 313 of the mediation server 110 (step S40), the second generation unit 316 judges whether the commodity for which sale/purchase has been established is a commodity via a member shop or not (step S41).

As described before, if the commodity is a commodity via a member shop, purchase information about the commodity is registered with the purchase information database DB2. When judging that the commodity is a commodity via a member shop because the purchase information is registered (step S41: YES), the second generation unit 316 generates sale/purchase information as shown in FIG. 17 based on the purchase information (step S42). Then, the second generation unit 316 stores the generated sale/purchase information into the sale/purchase information database DB4 and also sends it to the communication unit 311.

When receiving the sale/purchase information about the commodity via a member shop, the communication unit 311 transmits it to the settlement terminal 130 of a corresponding member shop (step S43). The transmission destination of the sale/purchase information is not limited to the settlement terminal 130 of the member shop but may be any terminal capable of receiving and displaying the sale/purchase information (for example, a display device or the like).

On the other hand, if judging that the commodity for which sale/purchase has been established is not a commodity via a member shop (step S41: NO), the second generation unit 316 ends the process without generating sale/purchase information.

When receiving the sale/purchase information, the settlement terminal 130 of the member shop displays it on its display (step S44). A staff member or the like of the member shop can grasp information about how long and in what price range, which commodity is on secondary distribution, by confirming the sale/purchase information displayed on the display. Thereby, it is possible for the member shop to obtain information to adjust the number of commodities to be sold, the time and the price.

The staff or the like of the member shop may distribute benefit information such as a coupon and an advertisement from the settlement terminal 130 to the user terminal 120 so that a user who sold the commodity will come to the shop again.

Various benefit information may be transmitted to the user terminal 120 based on the information grasped by the member shop. In this case, the benefit information to be transmitted may be selected according to the purchase price at the member shop and the price at the establishment of the sale/purchase on the electronic commerce platform. As a non-limiting example, if the price at the establishment of the sale/purchase on the electronic commerce platform is higher than the purchase price at the member shop, the user who listed the commodity got a profit by the listing, and, therefore, an advertisement (advertisement information) about the member shop is simply selected as the benefit information. If the price at the establishment of the sale/purchase on the electronic commerce platform is lower than the purchase price at the member shop, a coupon (discount) available at the member shop is selected. The benefit information may be such that is related to the purchased commodity. As a non-limiting example, the benefit information may be selected based on the category and price of the purchased commodity.

### Application Common to Embodiments and Examples

Recently, problems such as listing forgeries, such as so-called copy products and fake brand goods, have been rampant on electronic commerce platforms. In order to solve such problems, block chain technology enabling traceability of a distribution route may be utilized. For example, NFC chips for identifying genuine products are embedded in commodities sold at member shops, and information in the chips is managed by a block chain. It is almost impossible to falsify the block chain. Therefore, if a commodity is mounted with an NFC chip, the commodity can be judged to be genuine. Furthermore, since it is possible to trace a distribution history by utilizing the block chain technology, it is possible to check whether a commodity has not been obtained through an illegal route, such as theft. Therefore, a user can feel safe in using an electronic commerce platform. Furthermore, even if the N-th distribution occurs after the secondary distribution, all the distributions can be referred to. According to each of the embodiments and examples described above, it becomes possible to improve operability and usability of an information processing apparatus and a terminal accompanying execution of the applications and information processing method described above, in addition to the operation and effects already described.

### (Supplementary Note 1-1)

An information processing method for an information processing apparatus providing an electronic commerce platform where sale/purchase of a commodity via a network is performed between a user who wants to sell the commodity and a user who wants to purchase the commodity, the information processing method including:

a reception step of, when any of commodities is purchased at a member shop providing purchase information about the commodities to the information processing apparatus, receiving purchase information about the purchased commodity from an information processing apparatus of the member shop or an information processing apparatus of a user who has purchased the commodity;

a generation step of generating listed commodity information for selling the commodity using the electronic commerce platform based on the received purchase information about the commodity; and

a display step of causing at least a part of the generated listed commodity information to be displayed on the information processing apparatus of the user.

### (Supplementary Note 1-2)

The information processing method according to supplementary note 1-1, wherein, at the generation step, the listed commodity information is generated when an application for sale of the commodity using the electronic commerce platform is received from the information processing apparatus of the user who purchased the commodity.

### (Supplementary Note 1-3)

The information processing method according to supplementary note 1-1 or 1-2, wherein the purchase information includes at least one of identification information about the member shop that is a purchase place of the commodity, identification information about the user who purchased the commodity, commodity information about the commodity, purchase date and time information and purchase price information.

### (Supplementary Note 1-4)

The information processing method according to any of supplementary notes 1-1 to 1-3, wherein the listed commodity information includes at least one of commodity information about the commodity, use period information and recommended sale price information.

### (Supplementary Note 1-5)

The information processing method according to supplementary note 1-4, wherein, at the generation step, a quality state of the commodity is estimated based on purchase date and time information included in the purchase information about the commodity.

### (Supplementary Note 1-6)

The information processing method according to supplementary note 1-5, wherein, at the generation step, the estimated quality state of the commodity is reflected on the recommended sale price information.

### (Supplementary Note 1-7)

The information processing method according to supplementary note 1-4, wherein, at the generation step, the information processing apparatus acquires market price information about the commodity based on at least a part of the purchase information about the commodity, and includes the acquired market price information into the listed commodity information as the recommended sale price information.

### (Supplementary Note 1-8)

The information processing method according to supplementary note 1-7, wherein the market price information is information created based on sale/purchase results of the electronic commerce platform.

### (Supplementary Note 1-9)

The information processing method according to any of supplementary notes 1-1 to 1-8, further including an information provision step of generating benefit information prompting sale of the commodity using the electronic commerce platform and transmitting the generated benefit information to the information processing apparatus of the user.

### (Supplementary Note 1-10)

The information processing method according to supplementary note 1-9, wherein the benefit information is information showing a coupon available in the member shop where the commodity was purchased or an advertisement.

### (Supplementary Note 1-11)

The information processing method according to supplementary note 1-9, wherein the benefit information is information showing timing of selling the commodity using the electronic commerce platform.

### (Supplementary Note 1-12)

The information processing method according to supplementary note 1-9, wherein the benefit information is information showing a commodity that can be newly purchased by selling the commodity using the electronic commerce platform.

### (Supplementary Note 1-13)

An information processing apparatus providing an electronic commerce platform where sale/purchase of a commodity via a network is performed between a user who wants to sell the commodity and a user who wants to purchase the commodity, the information processing apparatus including:

a reception unit receiving, when any of commodities is purchased at a member shop providing purchase information about the commodities to the information processing apparatus, purchase information about the purchased commodity from an information processing apparatus of the member shop or an information processing apparatus of a user who has purchased the commodity;

a generation unit generating listed commodity information for selling the commodity using the electronic commerce platform based on the received purchase information about the commodity; and

a display unit causing at least a part of the generated listed commodity information to be displayed on the information processing apparatus of the user.

### (Supplementary Note 1-14)

A program causing an information processing apparatus providing an electronic commerce platform where sale/purchase of a commodity via a network is performed between a user who wants to sell the commodity and a user who wants to purchase the commodity to execute:

a reception step of, when any of commodities is purchased at a member shop providing purchase information about the commodities to the information processing apparatus, receiving purchase information about the purchased commodity from an information processing apparatus of the member shop or an information processing apparatus of a user who has purchased the commodity;

a generation step of generating listed commodity information for selling the commodity using the electronic commerce platform based on the received purchase information about the commodity; and

a display step of causing at least a part of the generated listed commodity information to be displayed on the information processing apparatus of the user.

### (Supplementary Note 2-1)

An information processing method for an information processing apparatus providing an electronic commerce platform where sale/purchase of a commodity via a network is performed between a user who wants to sell the commodity and a user who wants to purchase the commodity, the information processing method including:

a reception step of, when any of commodities is purchased at a member shop providing purchase information about the commodities to the information processing apparatus, receiving purchase information about the purchased commodity from an information processing apparatus of the member shop or an information processing apparatus of a user who has purchased the commodity;

an acceptance step of accepting an application for sale of the commodity from the information processing apparatus of the user who purchased the commodity;

a generation step of, when sale/purchase of the commodity for which the application for sale has been accepted is established, generating sale/purchase information about the sale/purchase of the commodity; and

a transmission step of transmitting at least a part of the generated sale/purchase information to the information processing apparatus of the member shop that is a purchase place of the commodity.

### (Supplementary Note 2-2)

The information processing method according to supplementary note 2-1, wherein the purchase information includes at least one of identification information about the member shop that is a purchase place of the commodity, identification information about the user who purchased the commodity, commodity information about the commodity, purchase date and time information and purchase price information.

### (Supplementary Note 2-3)

The information processing method according to supplementary note 2-1 or 2-2, wherein the sale/purchase information includes at least one of period information indicating a period until the application for sale is accepted after the commodity is purchased, and sale/purchase price information about the commodity.

### (Supplementary Note 2-4)

The information processing method according to supplementary note 2-1 or 2-2, further including an information provision step of transmitting benefit information to the user who purchased the commodity, or the user who sold the commodity based on the establishment of the sale/purchase on the electronic commerce platform.

### (Supplementary Note 2-5)

The information processing method according to supplementary note 2-4, wherein the benefit information is associated with the member shop that sold the commodity to the user who has sold the commodity before the establishment of the sale/purchase.

### (Supplementary Note 2-6)

The information processing method according to supplementary note 2-5, wherein a classification of the benefit information is changed according to comparison between a sale price of the commodity and a price at the establishment of the sale/purchase of the commodity on the electronic commerce platform.

### (Supplementary Note 2-7)

The information processing method according to supplementary note 2-6, wherein, if the sale price of the commodity is equal to or higher than the price at the establishment of the sale/purchase of the commodity on the electronic commerce platform, the benefit information is advertisement information.

### (Supplementary Note 2-8)

The information processing method according to supplementary note 2-6, wherein, if the sale price of the commodity is equal to or lower than the price at the establishment of the sale/purchase of the commodity on the electronic commerce platform, the benefit information is discount information.

### (Supplementary Note 2-9)

An information processing apparatus providing an electronic commerce platform where sale/purchase of a commodity via a network is performed between a user who wants to sell the commodity and a user who wants to purchase the commodity, the information processing apparatus including:

a reception unit receiving, when any of commodities is purchased at a member shop providing purchase information about the commodities to the information processing apparatus, purchase information about the purchased commodity from an information processing apparatus of the member shop or an information processing apparatus of a user who has purchased the commodity;

an acceptance unit accepting an application for sale of the commodity from the information processing apparatus of the user who purchased the commodity;

a generation unit generating, when sale/purchase of the commodity for which the application for sale has been accepted is established, sale/purchase information about the sale/purchase of the commodity; and

a transmission unit transmitting at least a part of the generated sale/purchase information to the information processing apparatus of the member shop that is a purchase place of the commodity.

### (Supplementary Note 2-10)

A program causing an information processing apparatus providing an electronic commerce platform where sale/purchase of a commodity via a network is performed between a user who wants to sell the commodity and a user who wants to purchase the commodity to execute:

a reception step of, when any of commodities is purchased at a member shop providing purchase information about the commodities to the information processing apparatus, receiving purchase information about the purchased commodity from an information processing apparatus of the member shop or an information processing apparatus of a user who has purchased the commodity;

an acceptance step of accepting an application for sale of the commodity from the information processing apparatus of the user who purchased the commodity;

a generation step of, when sale/purchase of the commodity for which the application for sale has been accepted is established, generating sale/purchase information about the sale/purchase of the commodity; and

a transmission step of transmitting at least a part of the generated sale/purchase information to the information processing apparatus of the member shop that is a purchase place of the commodity.

### CROSS-REFERENCE TO RELATED APPLICATION

The present application is based on Japanese Patent Application No. 2018-139485 filed on Jul. 25, 2018, the disclosed content of which is incorporated herein.

What is claimed is:

1. An information processing method for an information processing apparatus providing an electronic commerce platform where sale/purchase of a commodity via a network is performed between a user who wants to sell the commodity and a user who wants to purchase the commodity, the information processing method comprising:
electrically receiving purchase information about purchased commodity from an information processing apparatus of a member shop or an information processing apparatus of a user who has purchased the commodity when any of commodities is purchased at the member shop providing purchase information about the commodities to the information processing apparatus;
generating listed commodity information for selling the commodity using the electronic commerce platform based on the received purchase information about the commodity; and
causing at least a part of the generated listed commodity information to be displayed on the information processing apparatus of the user; wherein
the listed commodity information is generated when an application for listing the commodity on the electronic commerce platform is received from the information processing apparatus of the user who purchased the commodity.

2. The method of claim 1, wherein the purchase information includes at least one of identification information about the member shop that is a purchase place of the commodity, identification information about the user who purchased the commodity, commodity information about the commodity, purchase date and time information and purchase price information.

3. The method of claim 1, wherein the listed commodity information includes at least one of the commodity information about the commodity, use period information and recommended sale price information.

4. The method of claim 3, wherein the purchase information includes purchase date and time information about the commodity; and
a quality state of the commodity is estimated based on the purchase date and time information included in the purchase information about the commodity.

5. The method of claim 4, wherein the estimated quality state of the commodity is applied to the recommended sale price information.

6. The method of claim 3, wherein the information processing apparatus acquires market price information about the commodity based on at least a part of the purchase information about the commodity, and includes the acquired market price information into the listed commodity information as the recommended sale price information.

7. The method of claim 6, wherein the market price information is information created based on sale/purchase results on the electronic commerce platform.

8. The method of claim 1, further comprising:
generating benefit information prompting sale of the commodity using the electronic commerce platform and transmitting the generated benefit information to the information processing apparatus of the user.

9. The method of claim 8, wherein the benefit information is information related to a coupon or an advertisement available in the member shop where the commodity was purchased.

10. The method of claim 8, wherein the benefit information is information related to timing of listing the commodity using the electronic commerce platform.

11. The method of claim 8, wherein the benefit information is information related to a commodity that can be newly purchased by selling the commodity using the electronic commerce platform.

12. An information processing apparatus providing an electronic commerce platform where sale/purchase of a commodity via a network is performed between a user who wants to sell the commodity and a user who wants to purchase the commodity, the information processing apparatus comprising:
electronically receiving purchase information about purchased commodity from an information processing apparatus of a member shop or an information processing apparatus of a user who has purchased the commodity when any of commodities is purchased at the member shop providing purchase information about the commodities to the information processing apparatus;
generating listed commodity information for selling the commodity using the electronic commerce platform based on the received purchase information about the commodity; and
causing at least a part of the generated listed commodity information to be displayed on the information processing apparatus of the user; wherein
the listed commodity information is generated when an application for listing the commodity on the electronic commerce platform is received from the information processing apparatus of the user who purchased the commodity.

13. A computer-readable non-transitory storage medium storing a program, the program causing an information processing apparatus providing an electronic commerce platform where sale/purchase of a commodity via a network is performed between a user who wants to sell the commodity and a user who wants to purchase the commodity to execute:
electronically receiving purchase information about purchased commodity from an information processing apparatus of a member shop or an information processing apparatus of a user who has purchased the commodity when any of commodities is purchased at the member shop providing purchase information about the commodities to the information processing apparatus;
generating listed commodity information for selling the commodity using the electronic commerce platform based on the received purchase information about the commodity; and
causing at least a part of the generated listed commodity information to be displayed on the information processing apparatus of the user; wherein
the listed commodity information is generated when an application for listing the commodity on the electronic commerce platform is received from the information processing apparatus of the user who purchased the commodity.
